(19) United States
(12) Patent Application Publication
(10) Pub. No.: US 2010/0126128 A1
(43) Pub. Date: May 27, 2010

(54) RIGID CELL FILTER ASSEMBLY

(76) Inventor: RICHARD J. SCOTT, III, Fairhope, AL (US)

Correspondence Address: RICHARD J. SCOTT, III, 20297 MARION COURT, FAIRHOPE, AL, 36532, US

(21) Appl. No.: 12/277,703

(22) Filed: Nov. 25, 2008

(51) Int. Cl. B01D 35/30; B01D 46/52

(52) U.S. Cl. 55/494

(57) ABSTRACT

A rigid cell filter assembly is described; wherein the rigid cell filter assembly includes a filter header, filter media, and a plurality of support grids coupled to the header. The media adheres and couples to the support grids. The header and the support grids are injection molded as a single part from a plastic material. Alternatively, the media is plastic injection molded as a single part with the header and the support grids. The rigid cell filter assembly includes optional living hinges wherein the living hinges are plastic injection molded as a single part with the header and the support grids.

### FIELD OF THE INVENTION

This invention relates to filters. More particularly, the present invention relates to a rigid cell filter assembly that is injection molded as a single part from a plastic material.

### BACKGROUND OF THE INVENTION

Rigid cell filters are extended surface filters with metal cell sides and pleat construction that is tapered. Filter media is housed in a rigid galvanized, plastic or chipboard frame, with an optional header, and is bonded to a wire mesh before being bonded into the frame. The tapered pleat is further stabilized by laterally connecting cardboard, plastic or metal fingers (or separators), preventing media movement.

The rigid cell filters are designed for use as filters in areas such as hospitals, laboratories, pharmaceuticals or as pre-filters to high efficiency particulate air (HEPA) filters. These Filters may be used in spaces requiring 4″, 6″ or 12″ deep filters and are available in traditional box style or single header versions.

The background art includes many different types of filter apparatus and rigid cell filters for air filtration. For example, U.S. Pat. No. 6,723,150, issued to Parker, discloses an air filter assembly including a plastic frame containing an air permeable filter media. The media is shaped to provide a series of pleats. The filter frame can be plastic injection molded with integral living hinges to enable the frame to fold from a relatively flat shape to a more box-like structure. The frame includes one or more flip-up saw tooth racks that help define a main series of chambers plus a storage chamber. The main series of chambers supports a portion of the media that is more loosely folded for filtering air. Parker also discloses a method of inserting a filter media into a core—the cores includes a saw tooth rack which is pivoted to the frame—having a plurality of chambers and an adjacent storage chamber wherein the second plurality of pleats in the storage chamber are more tightly folded than the first plurality of pleats.

U.S. Patent Pub. No. 2006/0277879, filed in the name of Knowles, describes an air filter comprising a filter flange with a gasket that is sized to fit within a filter receptacle of the air grille, such that when the cover is closed, the cover flange seals against the cover and the filter receptacle. The gasket is affixed to a housing that is sized to extend beyond the filter receptacle into the duct extending beyond the return air grille. An extended heat filter is contained within and sealed to the walls of the housing such that air passing through the return air grille substantially passes through the air filter prior to entering the remainder of the return air duct.

U.S. Pat. No. 6,464,745, issued to Rivera et al., describes a minipleat synthetic filter assembly that includes a frame assembly and a section of synthetic minipleat filter media mounted within the frame assembly. The filter assembly of Rivera is typically used in air filtration applications, such as HVAC applications, although other filtration applications may also utilize the present filter assembly. The frame assembly is square or rectangular and formed of four corner members and four side members and can be assembled to form the frame assembly. The corner members are formed from a plastic material and by injection molding.

There are many problems associated with prior rigid cell filters. For example, since they are assembled from at least 15 to 20 parts, more parts mean lesser integrity and greater assembly time and piece part price, and more chance for mistakes in the manufacturing process. Significant labor savings and increased integrity can be realized by eliminating costs associated with machining, cutting, screwing and clean-up operations following the machining and cutting steps.

What is needed is a rigid cell filter assembly that consolidates the number of parts from at least 15 to 20 parts to 1 part and that eliminates costs associated with the machining and cutting of the rigid cell filter assembly.

### SUMMARY OF THE INVENTION

The present invention is directed to a rigid cell filter assembly. In one embodiment, the rigid cell filter assembly comprises a filter header; filter media; and a plurality of support grids coupled to the header. The media adheres and couples to the support grids. The header and the support grids are injection molded as a single part from a plastic material. The rigid cell filter assembly can further comprise one or more living hinges coupled to the header, wherein the hinges are utilized to strap shut a trailing edge of the media, and wherein the living hinges are plastic injection molded as a single part with the header and the support grids. An adhesive is applied to the support grids.

The filter media of the rigid cell filter assembly is pleated and comprises one of fiberglass and synthetic media. In one embodiment, the media is a polypropylene lofted microfiber. In another embodiment, the media is plastic injection molded as a single part with the header and the support grids.

In an alternative embodiment of the present invention, a rigid cell filter assembly is disclosed. The rigid cell filter assembly comprises a filter header; filter media; and a plurality of support grids coupled to the header, wherein the media couples and adheres to the support grids, and wherein the header, the media and the support grids are injection molded as a single part from a plastic material. In one embodiment, the filter assembly further includes one or more living hinges coupled to the header, wherein the living hinges are plastic injection molded as a single part with the header, the media and the support grids. The filter assembly may be formed using any injection molding technique, equipment, and/or machine known in the art.

### BRIEF DESCRIPTION OF THE DRAWINGS

FIG. 1 shows a perspective view of a rigid cell filter assembly in accordance with one embodiment of the present invention.

FIG. 2 shows a side elevation view of a rigid cell filter assembly in accordance with one embodiment of the present invention.

### DETAILED DESCRIPTION OF THE PREFERRED EMBODIMENTS

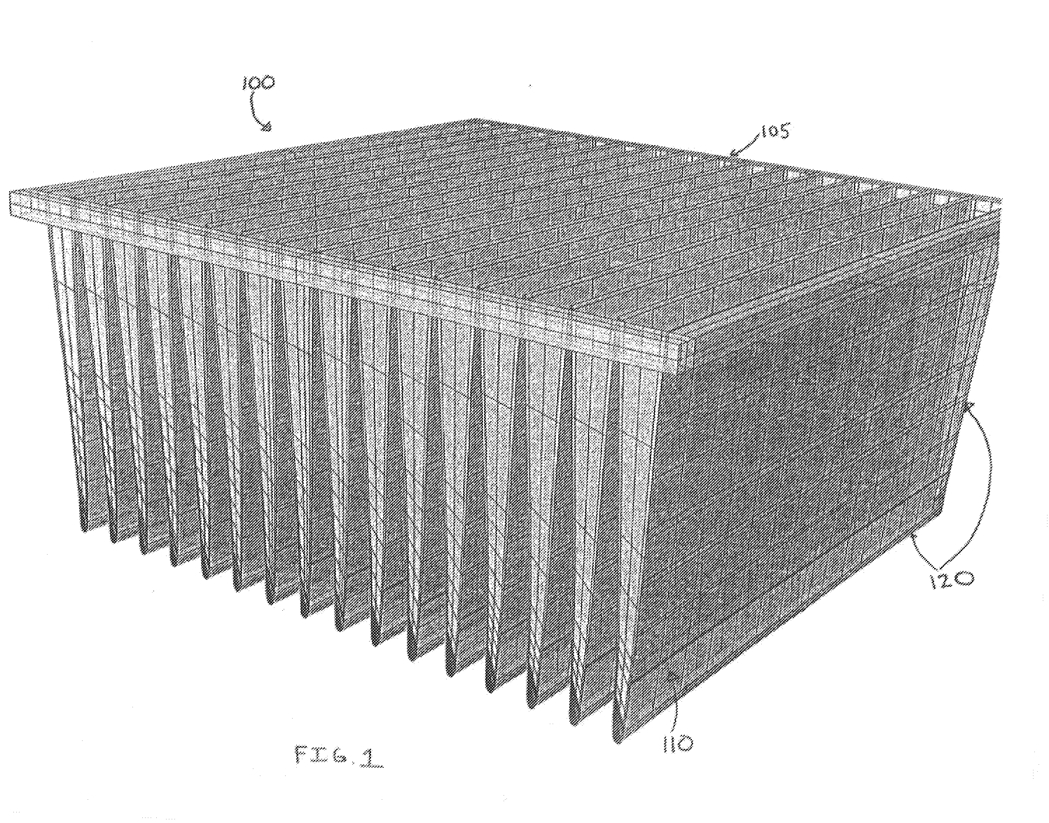

FIG. 1 shows a perspective view of a rigid cell filter assembly 100 for air filtration that is injection molded as a single one-piece unit from a plastic material, in accordance with one embodiment of the present invention. The filter assembly 100 includes a header (or header frame or holding frame) 105, filter media I 10, and a plurality of support grids 120 coupled to the header 105. The media 110 adheres and couples to the support grids 120. The header 105 and the support grids 120 are injection molded as a single part from a plastic material. In one embodiment, the assembly 100 further includes one or more living hinges (not shown) coupled to the header 105. The living hinges can be utilized to strap shut a trailing edge of the media. It will be appreciated that the living hinges are only optional and that, if utilized, the living hinges would also be plastic injection molded as a single part with the header 105 and the support grids 120. The filter assembly 100 may be formed using any injection molding technique, equipment, and/or machine known in the art.

An adhesive is applied to the assembly 100. Edges and sides of the media 110 are adhered to the support grids 120 using an adhesive. The header 105 may be of any suitable type, e.g. for front, rear or side withdrawal mounting. The media 110 is pleated.

Any media, including any number or combination of materials, can be inserted or I 0 used in the filter assembly 100. For example, materials of dimensionally planned, spun or chopped glass fibers or synthetic, or natural fiber materials can be employed. In one embodiment, a fibrous material of a pre-selected mixture by weight and number of glass and synthetic fiber material can be employed. In one embodiment, the media is polypropylene lofted microfiber. In other embodiments, dual denier polyester in 1 or 2 ply can be used. The material may be treated, e.g. with an antimicrobial agent to resist microbial mould growth and build up of moulds or mildews.

The header 105 and the support grids 120 are made of a plastic material and, in one embodiment, are made of the same material and are integrally formed in one piece by plastic injection molding. The plastic or thermoplastic material used for manufacturing the assembly 100 is at least one of the following: polystyrene, acrylonitrile butadiene styrene, polyamide, polypropylene, polyethylene, and polyvinyl chloride or PVC. Plastics reinforced with short fibers can also be injection molded.

In another embodiment of the present invention, the filter assembly 100 comprises the filter header 105, the filter media 10, and the support grids 120, wherein the header 105, the support grids 120 and the filter media 10 are all injection molded as a single part from a plastic material.

In another embodiment of the present invention, the filter assembly 100 comprises the filter header 105, the filter media 110, the support grids :120 and living hinges (not shown), wherein the header 105, the support grids 120, the filter media I 10 and the living hinges are all injection molded as a single part from a plastic material.

The rigid cell filter assembly 110 of the present invention allows inexpensive production of large quantities, while consolidating the number of parts from about 15 to 20 parts to 1 part. This decreases the piece part price while also decreases the labor costs involved.

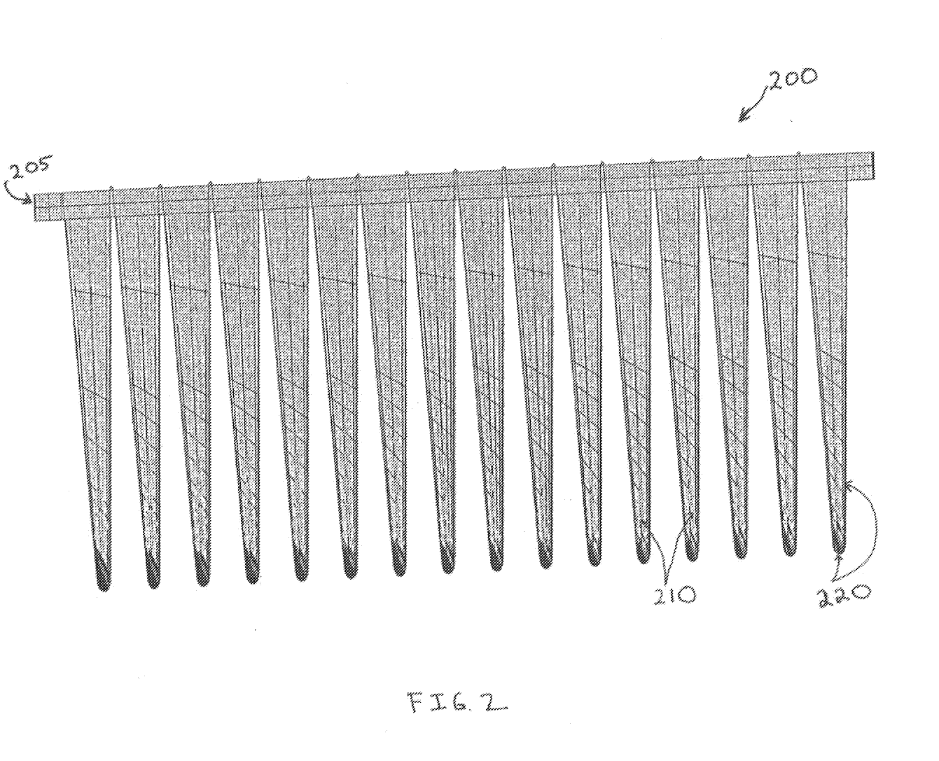

FIG. 2 describes a rigid cell filter assembly 200 that is injection molded as single one-piece unit from a plastic material, in accordance with one embodiment of the present invention. The filter assembly 200 includes a filter header 205, filter media 210, and a plurality of support grids 220. The header 205 and the support grids 220 are made of a plastic material and are made of a plastic injection-molded part. In another embodiment, the header 205, the support grids 220 and the media are all injection molded as a single part from a plastic material. The filter assembly 200 may be formed using any injection molding technique, equipment, and/or machine known in the art.

The rigid cell filter assembly of the present invention consolidates the number of parts from at least 15 to 20 parts to 1 part and eliminates costs associated with the machining and cutting of the rigid cell filter assembly. Fewer parts mean greater integrity and lower assembly time and piece part price, and less chance for mistakes ill the manufacturing process. Significant labor savings and increased integrity are realized by eliminating costs associated with machining, cutting, screwing and clean-up operations following the machining and cutting steps.

The present invention has been described in terms of specific embodiments incorporating details to facilitate the understanding of principles of construction and operation of the invention. Such reference herein to specific embodiments and details thereof is not intended to limit the scope of the claims appended hereto. It will be apparent to those skilled in the art that modification may be made in the embodiments chosen for illustration without departing from the spirit and scope of the invention

What is claimed is:

1. A rigid cell filter assembly comprising:
a. a filter header;
b. filter media; and
c. a plurality of support grids coupled to the header, wherein the media adheres and couples to the support grids, and wherein the header and the support grids are injection molded as a single part from a plastic material.

2. The filter assembly of claim 1 further comprising one or more living hinges coupled to the header, wherein the hinges are utilized to strap shut a trailing edge of the media, and wherein the living hinges are plastic injection molded as a single part with the header and the support grids.

3. The filter assembly of claim 1 wherein an adhesive is applied to the support grids.

4. The filter assembly of claim 1 wherein the media is pleated.

5. The filter assembly of claim 4 wherein the media comprises one of the following: fiberglass and synthetic media.

6. The filter assembly of claim 4 wherein the media is a polypropylene lofted microfiber.

7. The filter assembly of claim 1 wherein the media is plastic injection molded as a single part with the header and the support grids.

8. A rigid cell filter assembly comprising:
a. a filter header;
b. filter media; and
c. a plurality of support grids coupled to the header, wherein the media couples and adheres to the support grids, and wherein the header, the media and the support grids are injection molded as a single part from a plastic material.

9. The filter assembly of claim 8 further comprising one or more living hinges coupled to the header, wherein the hinges are utilized to strap shut a trailing edge of the media and wherein the living hinges are plastic injection molded as a single part with the header, the media and the support grids.

10. The filter assembly of claim 8 wherein an adhesive is applied to the support grids.

11. The filter assembly of claim 8 wherein the media is pleated.

12. The filter assembly of claim 11 wherein the media comprises one of the following: fiberglass and synthetic media.

13. The filter assembly of claim 11 wherein the media is a polypropylene lofted microfiber.
